(19) United States
(12) Patent Application Publication
(10) Pub. No.: US 2020/0301750 A1
(43) Pub. Date: Sep. 24, 2020

(54) METHOD FOR MITIGATING THE IMPACT OF NETWORK FUNCTION VIRTUALIZATION INFRASTRUCTURE (NFVI) SOFTWARE MODIFICATIONS ON VIRTUALIZED NETWORK FUNCTIONS (VNFs)

(71) Applicant: Maria TOEROE, Montreal (CA)

(72) Inventor: Maria TOEROE, Montreal (CA)

(73) Assignee: TELEFONAKTIEBOLAGET LM ERICSSON (PUBL), Stockholm (SE)

(21) Appl. No.: 16/765,690

(22) PCT Filed: Nov. 21, 2018
(86) PCT No.: PCT/IB2018/059188

§ 371 Date: May 20, 2020

Related U.S. Application Data
(60) Provisional application No. 62/590,048, filed on Nov. 22, 2017.

(51) Int. Cl. G06F 9/50; G06F 9/48; G06F 8/656; H04L 12/24; G06F 9/455

(52) U.S. Cl. CPC G06F 9/5088; G06F 9/5077; G06F 9/4875; G06F 2009/45595; H04L 41/0893; G06F 9/45558; G06F 8/656

(57) ABSTRACT

The disclosure relates to a method, executed by a NFVI Software Modification Manager, for coordination of Network Function Virtualization Infrastructure (NFVI) software modification. The method comprises identifying a Virtualized Resource (VR) impacted by the NFVI software modification; notifying a VNF-level Manager responsible for the coordination for the VR that the NFVI software modification is about to start; starting a timer with a lead time; upon expiry of the lead time, proceeding with the NFVI software modification; and notifying the VNF-level Manager that the NFVI software modification is completed. The disclosure also relates to a corresponding method executed by a Virtualized Network Function (VNF)-level Manager, as well as network nodes implementing these methods.

### PRIORITY STATEMENT UNDER 35 U.S.C. S.119(E) & 37 C.F.R. S.1.78

This non-provisional patent application claims priority based upon the prior U.S. provisional patent application entitled “METHOD FOR MITIGATING THE IMPACT OF NETWORK FUNCTION VIRTUALIZATION INFRASTRUCTURE (NFVI) SOFTWARE MODIFICATIONS ON VIRTUALIZED NETWORK FUNCTIONS (VNFs)”, application No. 62/590,048, filed Nov. 22, 2017, in the names of TOEROE.

### TECHNICAL FIELD

The present disclosure relates to software modifications and upgrades in the context of Network Function Virtualization (NFV).

### BACKGROUND

FIG. 1 illustrates the ETSI Network Function Virtualization (NFV) framework architecture 100 with the different functional blocks including the virtualized network functions (VNFs) 105 and the functional blocks of the NFV Management and Orchestration (MANO) 130 managing the VNFs 105 and the virtualized resources 120, 121, 122 used by the VNFs 105 as well as the different interfaces between these blocks.

Any of these functional blocks needs to go through software modifications (i.e. upgrades and updates) during their life cycle. This includes the NFV Infrastructure (NFVI) 110 on which the VNFs 105 are hosted, to provide their services. Thus, upgrading the NFVI 110 may impact the availability and continuity of the VNFs' services.

The ETSI NFV REL006 draft specification mandates the notification of the VNF 105 (or its manager 115) about an upcoming impact due to software modifications in the NFVI 110 in cases (a) when a virtualized resource (VR), such as a virtual machine (VM), virtual storage or virtual networking, or such as virtual links, virtual switches, virtual routers, etc. is going to be modified and/or (b) when the first resource of a virtualized resource group (VRG) such as an anti-affinity group is going to be impacted.

In both cases, the assumption is that the NFVI software modification manager (NFVI-SMM) has the information regarding to which VRs and VRGs it should provide the notification, how much in advance and which entity needs to be notified i.e. VNF 105 or its manager entity such as its element manager (EM) 115 or its VNF manager (VNFM) 140. Furthermore, this information also indicates the constraints for a VRG, on how many VRs can be taken out of a VRG, and, for a VR, if and under what constraints it can be migrated.

### SUMMARY

There is provided a method, executed by a NFVI Software Modification Manager, for coordination of Network Function Virtualization Infrastructure (NFVI) software modification. The method comprises identifying a Virtualized Resource (VR) impacted by the NFVI software modification; notifying a VNF-level Manager responsible for the coordination for the VR that the NFVI software modification is about to start; starting a timer with a lead time; upon expiry of the lead time, proceeding with the NFVI software modification; and notifying the VNF-level Manager that the NFVI software modification is completed.

The method may further comprise receiving a message from the VNF-level Manager informing whether coordination of NFVI software modifications is necessary for the VR, and informing of applicable constraints. The method may further comprise receiving a response from the VNF-level Manager informing that the VNF-level Manager is ready for the software modification and proceeding with the software modification of the NFVI resources may start before the lead time expires if all responses have been received. The lead time may be determined as a maximum lead time imposed by the constraints. The constraints may comprise any one or a plurality of: a need to notifying the VNF-level Manager that the NFVI software modification is about to start before the virtualized resources is impacted; an upper time limit at which virtual resource migration is feasible otherwise shutdown is preferred; a minimum number of virtual resources that need to be available; or a maximum number of virtual resources that can be impacted simultaneously.

The method may further comprise identifying that a plurality of VRs are impacted or that a VR Group is impacted and iterating until all NFVI resources supporting the plurality of VRs or the VR Group are modified.

There is provided a network node, executing a NFVI Software Modification Manager for coordination of Network Function Virtualization Infrastructure (NFVI) software modification. The network node runs in a cloud computing environment which provides processing and interface circuitry and memory for running the network node. The memory contains instructions executable by the processing circuitry whereby the network node is operative to execute any of the steps of the method described previously.

There is provided a method, executed by a Virtualized Network Function (VNF)-level Manager, for coordination of Network Function Virtualization Infrastructure (NFVI) software modification. The method comprises receiving a first notification from a NFVI Software Modification Manager that the NFVI software modification is about to start; initiating preparations for impacts caused by the NFVI software modification; and receiving a second notification from the NFVI Software Modification Manager about completion of the software modification.

The method may further comprise sending a message to the NFVI Software Modification Manager, informing whether coordination of NFVI software modifications is necessary for a virtualized resource (VR), and informing of applicable constraints. The method may further comprise scaling out to increase virtualized resource (VR) redundancy, and switching over an active role of a Virtual Network Function Component (VNCF) instance hosted on an impacted VR to a redundant VR. The method may further comprise informing the NFVI Software Modification Manager about its readiness for the NFVI software modification. The method may further comprise reversing configuration changes made in preparation to an impact caused by the NFVI software modification or workload rebalancing.

There is provided a network node, executing a Virtualized Network Function (VNF)-level Manager for coordination of Network Function Virtualization Infrastructure (NFVI) software modification. The network node runs in a cloud computing environment which provides processing and interface circuitry and memory for running the network node. The memory contains instructions executable by the processing circuitry whereby the network node is operative to execute any of the steps of the method described previously.

There is provided a method, executed by a Software Modification Manager (SMM), for mitigating impacts of a Network Function Virtualization Infrastructure (NFVI) software modification on a running Virtualized Network Function (VNF). The method comprises determining that a Virtualized Resource (VR) used by the VNF is to be impacted by the NFVI software modification; adding a new VR to be assigned to the VNF, to create redundancy for the impacted VR; and providing the new VR to the VNF, to allow the VNF to switch over the impacted VR to the new VR, thereby allowing the VNF to mitigate the impacts of the NFVI software modification.

The method may further comprise, after determining that a VR is to be impacted, starting a lead time timer indicative of a remaining time left to switch over the impacted VR and signaling to a VNF Manager (VNFM) of the VNF that a VR of the VNF is impacted by the NFVI software modification. The signaling to the VNFM of the VNF that the VR of the VNF is impacted by the NFVI software modification may further comprise signaling that the impacted VR needs to be shut down or migrated. The method may further comprise, after the shutting down or while migration of the VR is completed, re-creating the VR. The method may further comprise adding VRs of the VNF to a Virtualized Resource Group (VRG), and determining that the VR used by the VNF is to be impacted by the NFVI software modification may comprise determining that the VRG comprising the VR is impacted. The method may be executed iteratively, and the re-created VR may be used as the new VR to which another impacted VR switches over. The NFVI software modification may comprise any one of NFVI upgrade, NFVI update, NFVI maintenance, NFVI diagnostics, or any other kind of modification.

There is provided a network node, executing Software Modification Manager (SMM), for mitigating impacts of a Network Function Virtualization Infrastructure (NFVI) software modification on a running Virtualized Network Function (VNF). The network node runs in a cloud computing environment which provides processing and interface circuitry and memory for running the network node. The memory contains instructions executable by the processing circuitry whereby the network node is operative to execute any of the steps of the method described previously.

There is provided a method, executed by a Virtualized Network Function (VNF) or an Element Manager of the VNF, for mitigating impacts of Network Function Virtualization Infrastructure (NFVI) software modification. The method comprises requesting a VNF Manager (VNFM) or a Virtual Infrastructure Manager (VIM) in a hosting NFV to provide at least one extra Virtual Resource (VR), before the NFVI upgrade impacts VRs used by the VNF; receiving the at least one extra VR; and receiving an indication of at least one impacted VR and using the at least one extra VR for switching over services running on the impacted VR to the at least one extra VR, thereby mitigating the impacts of the NFVI software modification.

At least one extra VR may be provided before a time when a first VR is impacted. The at least one extra VR may be provided before a time when a first VR of a group of VRs is impacted. The method may further comprise, in case the at least one extra VR is provided before the first VR of the group of VRs is impacted, switching over the at least one impacted VR using the indication and keeping the at least one extra VR for subsequent reuse for other impacted VRs. A number of needed extra VRs may be determined by constraints of simultaneous impact.

There is provided a network node executing a Virtualized Network Function (VNF) or an Element Manager of the VNF, for mitigating impacts of Network Function Virtualization Infrastructure (NFVI) upgrade/update/modification. The network node runs in a cloud computing environment which provides processing and interface circuitry and memory for running the network node. The memory contains instructions executable by the processing circuitry whereby the network node is operative to execute any of the steps of the method described previously.

There is provided a non-transitory computer readable media having stored thereon instructions for executing any of the steps of the methods described herein.

The methods, non-transitory computer readable media, network nodes provided herein present improvements to the way software modification, update and upgrade, of at least NFVI, in the context of Network Function Virtualization (NFV), is managed and executed.

### BRIEF DESCRIPTION OF THE DRAWINGS

FIG. 1 is a schematic illustration of the NFV framework architecture.

FIG. 2 is a diagram illustrating some problems with previous methods of VM migration that cause interferences at the VNF level.

FIG. 3 is a flow diagram according to an embodiment.

FIG. 4 is a flow diagram according to another embodiment.

FIGS. 5a and b is a flow diagram according to another embodiment.

FIGS. 6a and b is a flow diagram according to another embodiment.

FIG. 7 is a flowchart of a method according to an embodiment.

FIG. 8 is a flowchart of a method according to another embodiment.

FIG. 9 is a flowchart of a method according to an embodiment.

FIG. 10 is a flowchart of a method according to another embodiment.

### DETAILED DESCRIPTION

Various features and embodiments will now be described with reference to the figures to fully convey the scope of the disclosure to those skilled in the art.

Many aspects will be described in terms of sequences of actions or functions. It should be recognized that in some embodiments, some functions or actions could be performed by specialized circuits, by program instructions being executed by one or more processors, or by a combination of both.

Further, some embodiments can be partially or completely embodied in the form of computer-readable carrier or carrier wave containing an appropriate set of computer instructions that would cause a processor to carry out the techniques described herein.

In some alternate embodiments, the functions/actions may occur out of the order noted in the sequence of actions or simultaneously. Furthermore, in some illustrations, some blocks, functions or actions may be optional and may or may not be executed; these are generally illustrated with dashed lines.

The ETSI NFV specification gives no guidance for when and how the notifications (of the VNF, or its manager, about an upcoming impact due to software modifications in the NFVI in cases (a) when a VR is going to be modified and/or (b) when the first resource of a VRG is going to be impacted) can be used to minimize the impact of the NFVI software modification process on the VNF and its services.

For example, when a VR of a VNF has been impacted, the VNF requires a “rebuild time” to restore its redundancy after the impact and before its subsequent VR is impacted. This rebuild time would be in addition to the notification lead time proposed by the REL006 draft before an impact. That is, the lead time should allow VNFs to prepare for the upcoming impact, while the rebuild time would let the VNFs restore their redundancy so that the impact of their next VR does not cause data/state loss.

On the NFVI side, however, the introduction of such an additional period, especially if it is signaled by the VNFs (as opposed to a time out period), is very undesirable because it complicates the scheduling of the software modification of NFVI resources. This is because each of the NFVI resources may serve simultaneously multiple VNFs with very different needs in terms of these periods (rebuild time and notification lead time) and each of the VNFs may have their next VR on a different NFVI resource. Coordination of these needs can become very complex and may even halt the entire NFVI software modification process.

Nevertheless, there is a need to accommodate the VNFs' need to restore their redundancy.

What is proposed herein is to mitigate the impact of the NFV infrastructure software modification process on a VNF by providing at least one additional VR of the type being impacted by the time the next impacted VR is identified and the VNF is notified about it. This way, the VNF can replicate the content of the impacted VR on the provided one before the actual impact. The extra VR is released after the impact is over.

Extra VR can be provided and released for each impacted VR separately or for a VRG. The extra VR may be requested by the manager acting on behalf of the VNF e.g. VNFM or may be provided proactively by the NFVI-SMM.

The proposed solution introduces some attributes, which request to provide at least one extra VR to compensate for the impact of upcoming NFVI software modifications. This, in addition to the notifications of NFVI software modifications and their lead time, can be used to address the need of the VNFs to maintain their redundancy throughout the NFVI software modification. If the extra VRs are expected to be provided by the NFVI-SMM, then the attributes could be added to the information for the NFVI-SMM on the notification request/subscription and the impact constraints. If it is expected that the VNFM requests the extra VRs, then the information should be defined for the VNFM. It should indicate that it should request the extra VRs and under what circumstances and how many. The NFVO 135 could also be involved in the process and do some of the previously described tasks as there is a direct and indirect mode of VR allocation in NFV. Direct mode is when the VNFM interacts directly with the VIM for requesting VRs and in the indirect mode the requests go through the NFVO. In both cases the VR is given to the VNFM directly by the VIM. It should be noted that the NFVI-SMM should get its information about the constraints either from the VNFM (direct mode) or from the NFVO (indirect mode), so these managers (VNFM&NFVO) should have the same information.

Namely, it is proposed that the VNF is scaled out (either by the VNFM or the NFVI-SMM, which can be part of the Virtual Infrastructure Manager (VIM)), before the impact of a VR or a VRG, so that the lead time can be used for re-creating the redundancy on the additionally provided VR(s) as part of the preparation for the impact.

The attributes (additional to the impact tolerance attributes of REL006) indicate whether an extra VR needs to be provided or if a VRG scale out needs to be performed proactively by the NFVI-SMM or by the VNF manager (VNFM) managing the VNF being impacted, which subscribes for the impact notifications.

The proposed solution introduces some attributes, which are used to request the NFVI-SMM or the VNFM to provide extra virtual resources to compensate for the impact of NFVI software modifications. As a result, the hosted VNF can use the lead time of the impact notification proposed by the REL006 draft specification in a way that minimizes the impact of NFVI software modifications on the hosted VNF and maintains the VNF redundancy throughout the NFVI software modification process.

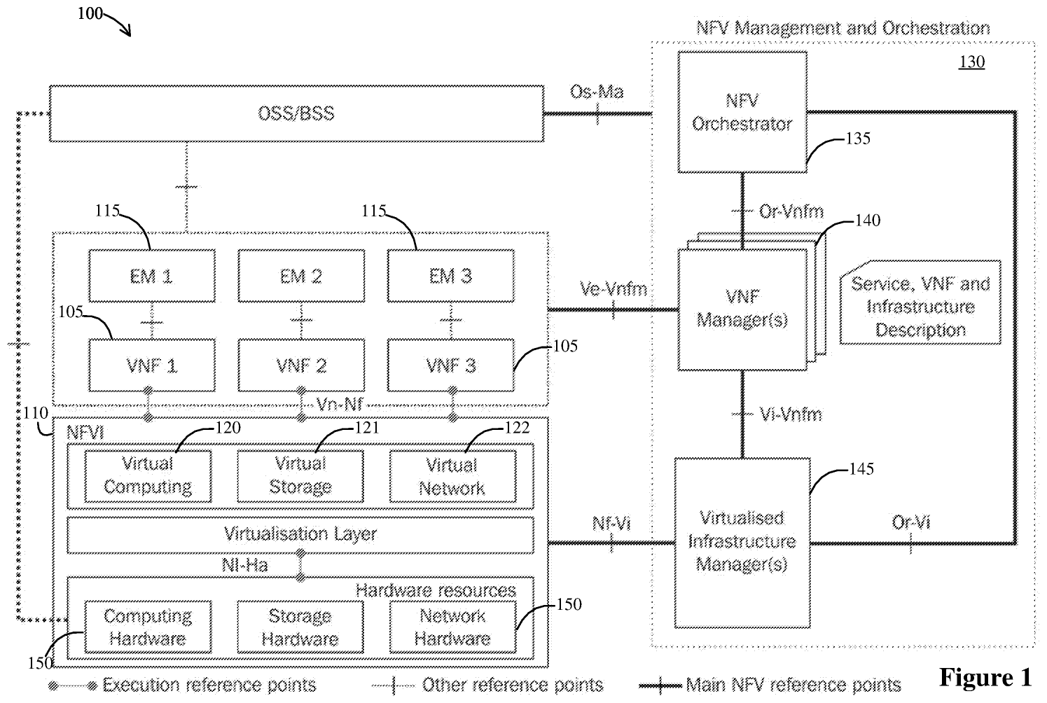

Referring again to FIG. 1, ETSI NFV defines the Network Function Virtualization (NFV) framework architecture 100 with the different functional blocks including the virtualized network functions (VNFs) 105 and the functional blocks of the NFV MANO 130 managing them and the virtualized resources 120, 121, 122 they use, as well as the different interfaces between these blocks.

Any of these functional blocks needs to go through software modifications (i.e. upgrades and updates) during their life cycle. This includes the NFV Infrastructure (NFVI) 110 on which the VNFs 105 are hosted to provide their services. Thus, upgrading the NFVI 110 may impact the availability and continuity of the VNFs' services.

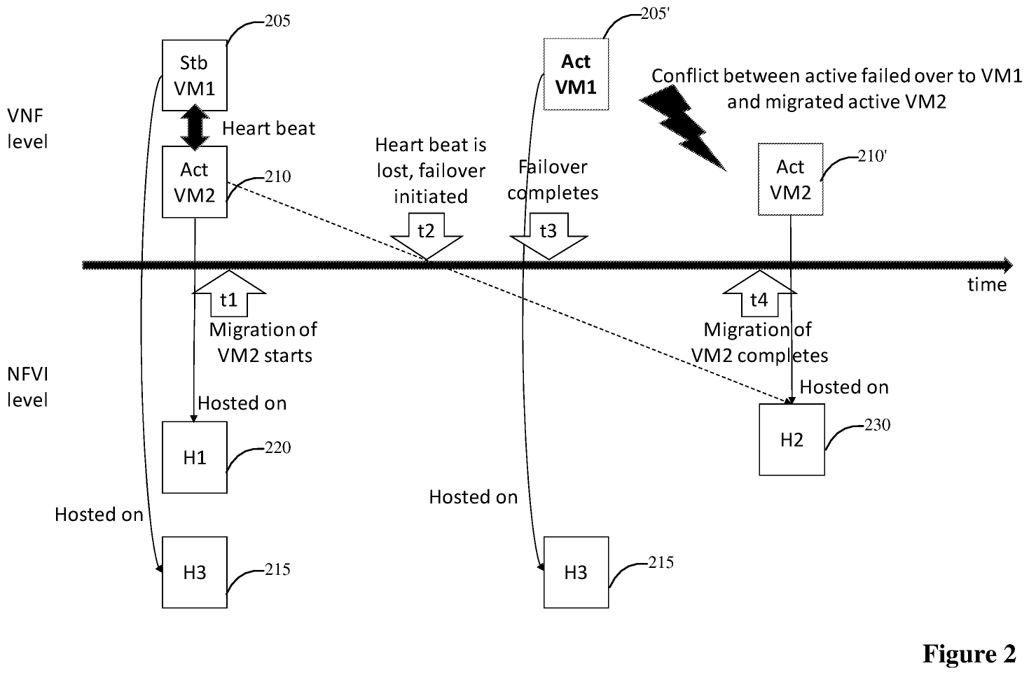

Typically, when the software of NFVI resources (in hardware and virtualization resources) is modified, the VRs hosted by the NFVI resources are impacted. The VRs either need to be migrated to another NFVI resource or be shut down for the time of the software modification. In the latter case, the VNF using the given VR is impacted, and needs to release the VR gracefully. But even the migration may cause an outage of the VR, that, at the VNF level, can be detected as a failure and can initiate a failover to another VR, as shown in FIG. 2.

In FIG. 2, there are two VRs VM1 205 and VM2 210 acting as an active-standby pair at the VNF level, heart-beating each other. In the figure, “Stb” denotes standby and “Act” denotes active. VM2 210 is hosted on host H1 220, and VM1 205 is hosted on H3 215.

VM2 210, the active one, is migrated from host H1 220 to host H2 230 at the NFVI level. The migration starts at time t1. At time t2, the standby VM1 205 loses the heart beat towards the active VM2 210, which is being migrated. This initiates a failover and VM1 205′ becomes active. However, when the migration of VM2 210 to host H2 230 completes at time t4, VM2 210′ comes back at the VNF level also as active since it was active at the initiation of the migration and it was not aware of its migration. This then interferes with the already active VM1 205′.

To avoid such situations VNFs may also need to release their VRs being migrated before the migration.

In either case since graceful release of a VR takes time, the ETSI NFV REL006 specification (draft at the filing date of this application) allows the specification of a lead time for a VR or VRG which specifies how much in advance before the impact the NFVI-SMM should issue a notification to the VNF or the entity acting on behalf of the VNF. Entities acting on behalf of the VNF could be the VNFM or the NFVO (NFV Orchestrator) 135 or possibly another entity. If the element manager (EM) 115 acts on behalf of the VNF, it is assumed that it is part of the VNF, as from the perspective of the NFV architectural framework the reference point towards the VNF and its EM are the same (Ve-Vnfm).

It should be noted that the location of the NFVI-SMM in this framework is not specified today. Considering the functionality of the NFVI-SMM, it is most likely to be part of the Virtual Infrastructure Manager (VIM) 145 functional block and, for the purpose of the explanations provided herein, we make this assumption. The methods provided herein are not limited, however, to an implementation of the NFVI-SMM in the VIM and a person skilled in the art should understand that the NFVI-SMM could be part or another functional block and provide similar functionalities as described herein.

Considering availability and reliability, taking away a VR from the VNF for software modification typically reduces the redundancy used at the VNF level for the time of the software modification. Hence, there is an impact at the VNF level. This redundancy needs to be restored after the impact, i.e. when the NFVI software modification is completed and the VR is returned to the VNF. This also takes time and therefore it is desirable to have a second time period associated with each impact, which would allow the VNF to restore its redundancy, so that it can tolerate the next impact. This second time-period can be referred to as rebuild time.

On the NFVI-SMM/VIM side, however, adding any waiting time for VNFs makes excessively complicated to schedule the software modification of NFVI resources, as each NFVI resource hosts more and more VNFs with different coordination needs using different overlapping sets of VRs. To avoid complicating matters, it is proposed to embed in the lead time the rebuild time, if it is possible, by adding redundancy (for example by starting VM(s)) beforehand.

The simplest case from a time setting perspective may be to add the two time periods together and request it as lead time for the notification of each VR. Then this period allows first to complete rebuilding any redundancy necessary in the VNF and subsequently to prepare for the next impact. In case the VNF uses VRs provided on a fixed set of NFVI resources this may be the only solution as no additional VR can be provided beforehand. In this case the VNF needs to rebuild its redundancy each time one of its VRs has been impacted and becomes available again after the impact.

However, if the VNF can use VRs provided on other NFVI resources, the VRs assigned to the VNF can be scaled out beforehand and used to provide extra VR(s) (eVR) to the VNF. This means that together with the information concerning which VR is being impacted next (iVR), the VNF can use the provided extra VR (eVR) to re-create the redundancy provided by the iVR to be taken away on the eVR. This way, the rebuild time effectively becomes part of the preparation/lead time for the impact and in addition there is no impact to the redundancy when the iVR is taken away.

Accordingly, it is proposed to provide the VNF with the necessary extra VR(s) by the time it is known which one of its current VRs is going to be impacted next. This way the VNF can use the lead time to recreate the content of the iVR to be impacted on the additional eVR provided. This means that the lead time needs to cover the replication time of iVR on eVR and the time needed to switch out from the iVR to the eVR. This should be requested as lead time for the VR impact notification. This also means that when the iVR is actually taken away for the NFVI software modification, the VNF redundancy is not impacted as it has been recreated on the additional eVR. In addition re-creating iVR on eVR in the presence of iVR might take significantly less time than when it is done in the absence of iVR.

The additional VR can be supplied to the VNF in different ways. First the VNF itself or the manager acting on its behalf, such as the VNFM, can subscribe for the notification for the VR and possibly the VRG impact. If the VNFM is expected to act on behalf of the VNF, this should be indicated by appropriate attributes for the VNF. The attributes should cover under what circumstances (for VRs or VRGs) and how much extra VR(s) the VNFM should request for the VNF.

When a VNFM is configured to request extra VRs for the time during which the NFVI resources (used by the VNF managed by the VNFM) will undergo software modifications, the VNFM subscribes to the NFVI-SMM notifications. Then, when the VNFM receives such a notification, it requests the extra VR(s) according to the applicable Life-Cycle Management (LCM) scale out procedure. The scale out procedure may include going through the NFVO 135 before requesting the extra VR(s) from the VIM.

When the VNFM receives the requested VR(s) from the VIM, it provides them to the VNF for the preparation to the impact, together with the indication of the VRs being impacted. It should be noted that considering that such a VR grant request towards the NFVO may exceed the quota assigned to the VNF, the request should indicate that the scale out is due to NFVI software modification impact so that the NFVO may apply special policy for granting requests due to NFVI software modification as opposed to VNF workload increase.

In this case, the notification lead time needs to take into account the time needed to obtain the extra VR. The extra VR(s) only need to be obtained once, if the notification for VRG impact is also used. This way, the extra VR(s) are obtained before the first set of VR(s) is impacted and then once the set of impacted VRs is known, the extra VRs are reused in each iteration impacting a new set of VRs within the VRG. If only a VR impact notification is used, the extra resource needs to be obtained for each single impact.

Once the NFVI-SMM signals the completion of the NFVI software modification of the VR or the VRG, the extra VR(s) obtained for the NFVI software modification are released by the VNF.

Alternatively, a new impact tolerance attribute may be specified for VRs and VRGs, which indicates to the NFVI-SMM whether it should provide the additional VR(s) at the time of the notification about the upcoming impact.

That is, the NFVI-SMM can also be requested to act proactively as it knows the VR(s) to be impacted and therefore is able to scale out that type of VR and provide it to the VNF. Thus, the NFVI-SMM can create the additional VRs and provide them to the manager subscribing on behalf of the VNF for the impact notifications. The provided VRs can be given together with the notification about the upcoming impact at the lead time requested. Again, once the NFVI software modification completes, the extra resources are returned by the VNF.

Considering the two types of notifications, i.e. for VR and for the VRG, the use of the VR notification allows the VNF to know which VR is being impacted next and therefore provides the information which is needed, for the VR to be replicated before the impact.

When only the VR impact notification is used, first, a VNF scale out needs to be performed for each impacted VR to create one additional resource to replace the impacted ones. Then, at the NFVI software modification, the impacted VR is taken away from the VNF i.e. a scale in is performed. This is repeated for each impacted VR. It should be noted that this is somewhat similar to VM migration, but, because the functional migration is performed at the VNF level by the VNF, there is no conflict. If the NFVI-SMM/VIM replicates the VR at the NFVI level, then a situation similar to the migration conflict described in FIG. 2 may arise.

When a VRG is used for redundancy, it is composed of identical VRs and therefore it can be scaled out when the first VR of the VRG is being impacted. The extra VR can be kept and reused by the VNF each time another VR of the VRG is impacted until the NFVI-SMM signals the completion of the NFVI software modification process for the VRG. Then the extra VR can be released.

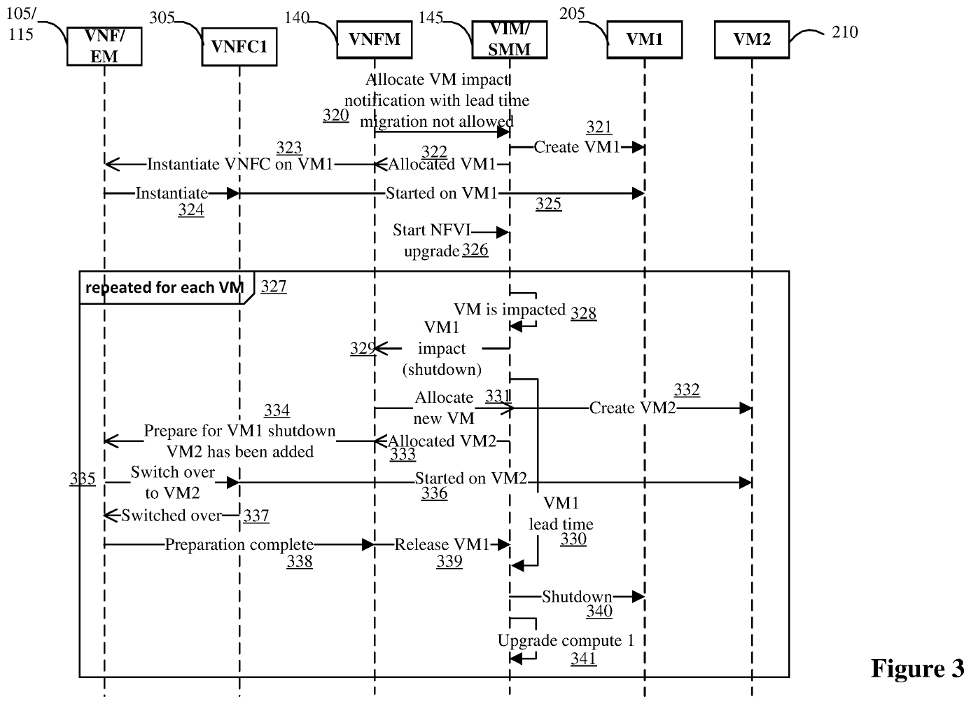

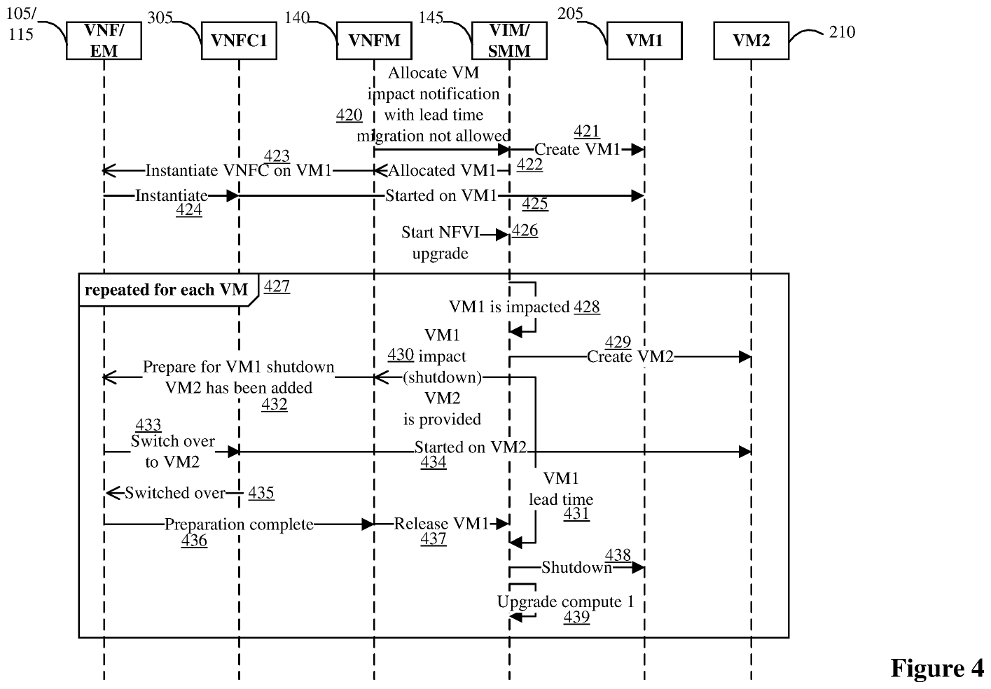

Example scenarios are shown in FIGS. 3 and 4. In both cases, it is assumed that the VIM also acts as the NFVI-SMM, which is indicated by the VIM/SMM instance 145. At step 320, 420, the VNFM 140 requests from the VIM 145 a VM 205 for the VNF 105 it manages, it also requests VM impact notifications with an appropriate lead time. It also indicates that migration of the VM 205 is not allowed. This means that the VM needs to be shut down in case of an NFVI resource upgrade. The VIM 145 creates VM1, step 321, 421. When the VNFM 140 receives the allocated VM1 205 from the VIM 145, step 322, 422, the VNFM 140 adds it to the VNF 105, step 323, 423, and VNFC1 305 instance is instantiated on it, steps 324, 325, 424, 425.

When the NFVI upgrade is initiated, step 326, 426, the VIM/SMM 145 identifies that VM1 is impacted, step 328, 428.

There are two possibilities from here. If the VNFM 140 handles the extra VRs on behalf of the VNF 105, i.e. VNFM 140 driven case shown in FIG. 3, then the VIM/SMM 145 notifies the VNFM 140 about the impact, step 329, and starts the impact lead time timer for VM1 205, step 330.

In the example of FIG. 3, the VNFM 140 receives the notification, step 329, and requests an extra VM from the VIM/SMM 145, step 331, which creates VM2 210, step 332, and in turn provides VM2 210, step 333, to the VNFM 140. Then, the VNFM 140 signals to the VNF 105 that VM1 205 is going to be shut down, step 334, and VM2 210 has been provided as a replacement. The VNF 105 then switches over its VNFC1 305 instance to the new VM2 210, steps 335-337, and by that is ready for the impact, which it indicates at step 338 to the VNFM, which can release VM1 205, step 339.

The VIM/SMM 145 can wait until the VM1 lead time timeout to shut down VM1 or may do so, step 340, when it receives the release indication from the VNFM 140. At this time, the VIM/SMM 145 can initiate the upgrade of the compute resource, step 341.

Alternatively, at the allocation of VM1 205 the VNFM 140 may also indicate that the VIM/SMM 145 should provide an extra VM when the VM is impacted. I.e. the VNFM 140 requests the VIM/SMM 145 to be proactive as shown in FIG. 4.

In the example of FIG. 4, the VIM/SMM 145 first creates VM2 210, step 429, to replace the to-be-impacted VM1 205 and provides this VM2 210 in the impact notification to the VNFM 140, step 430, and starts the lead time timer for VM1, step 431. The rest is similar to the previous case illustrated in FIG. 3, i.e. the VNFM 140 notifies the VNF 105 about the impact, together with the replacement VM2 210, step 432. The VNF 105 switches its VNFC1 305 to the provided extra VM2 210, steps 433-435, indicates that it is ready for impact, step 436, and releases VM1 205, step 437, so that the NFVI upgrade can proceed. VM1 is shut down, step 438 and the VIM/SMM 145 can initiate the upgrade of the compute resource, step 439.

If the VNF uses more than one VM 205, 210, the same procedure is repeated, 327, 427 for each VM 205, 210 impacted by the upgrade of NFVI resources. It should be noted that multiple VMs 205, 210 of the VNF 105 may be impacted simultaneously, but since extra VMs 205, 210 are provided for each impacted VM, the VNF 105 may be able to tolerate and prepare for the impact appropriately as the number of VMs 205, 210 in the VNF 105 remains the same. However, the simultaneous impact may not be tolerated in all cases or only to a limited extent. To limit the simultaneous impacts VRG should be used.

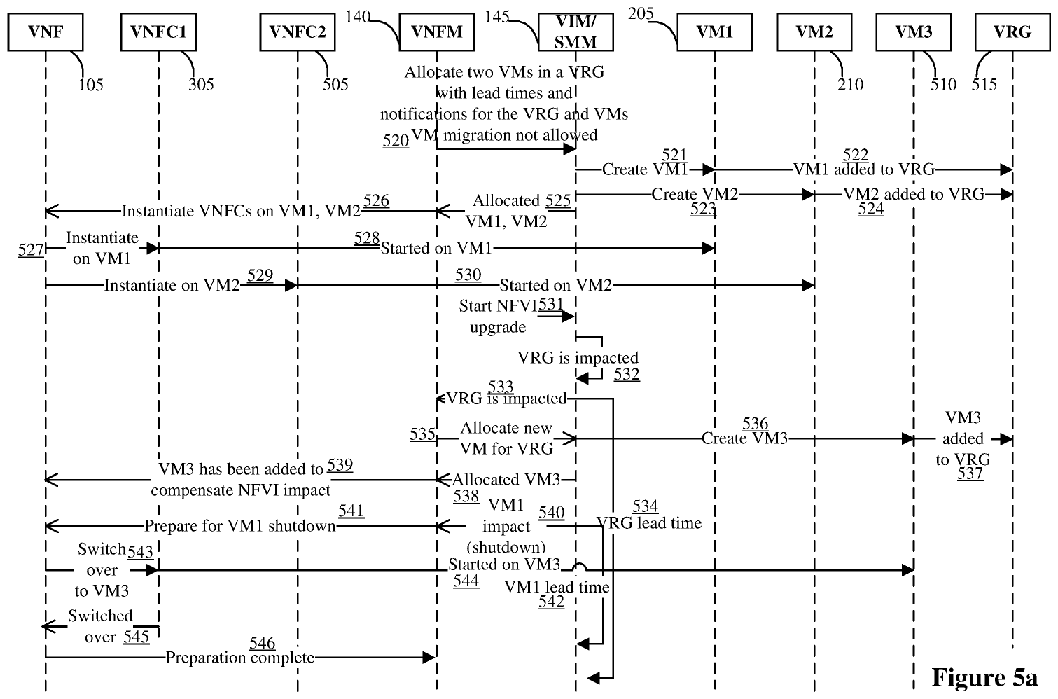

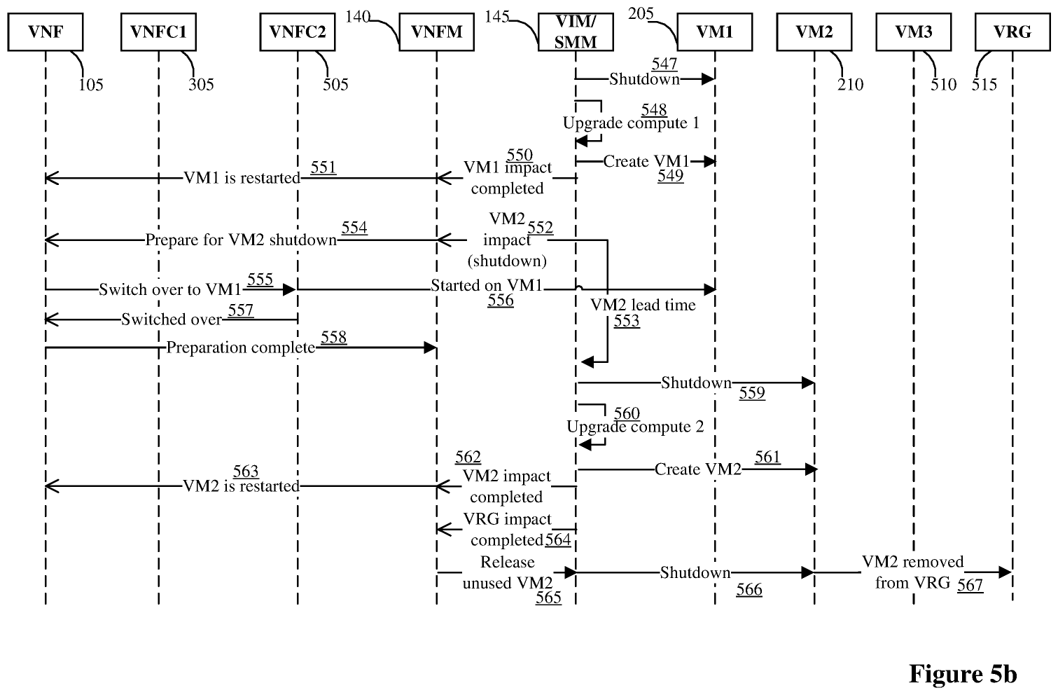

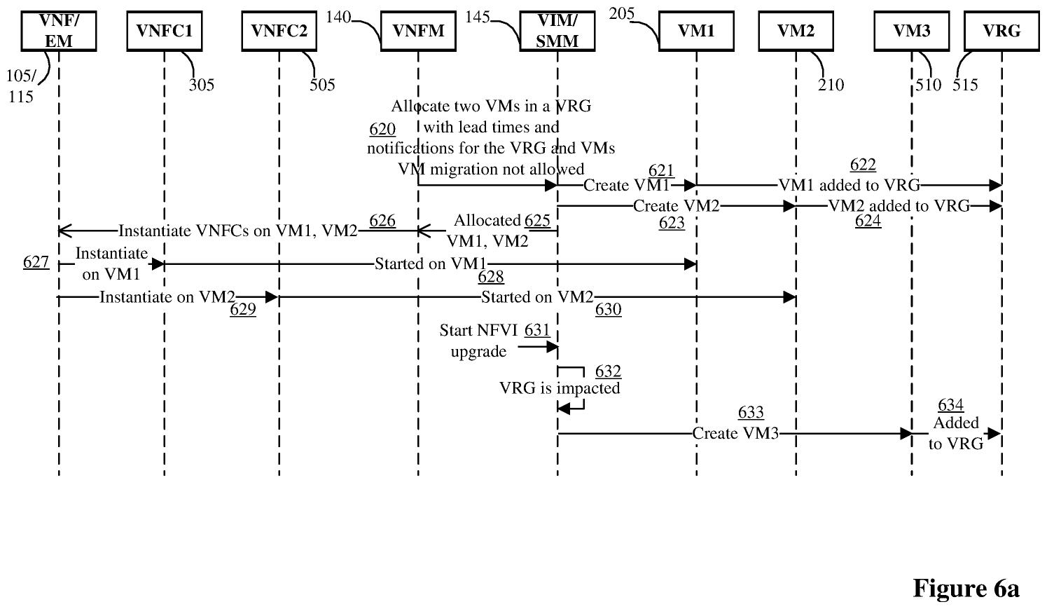

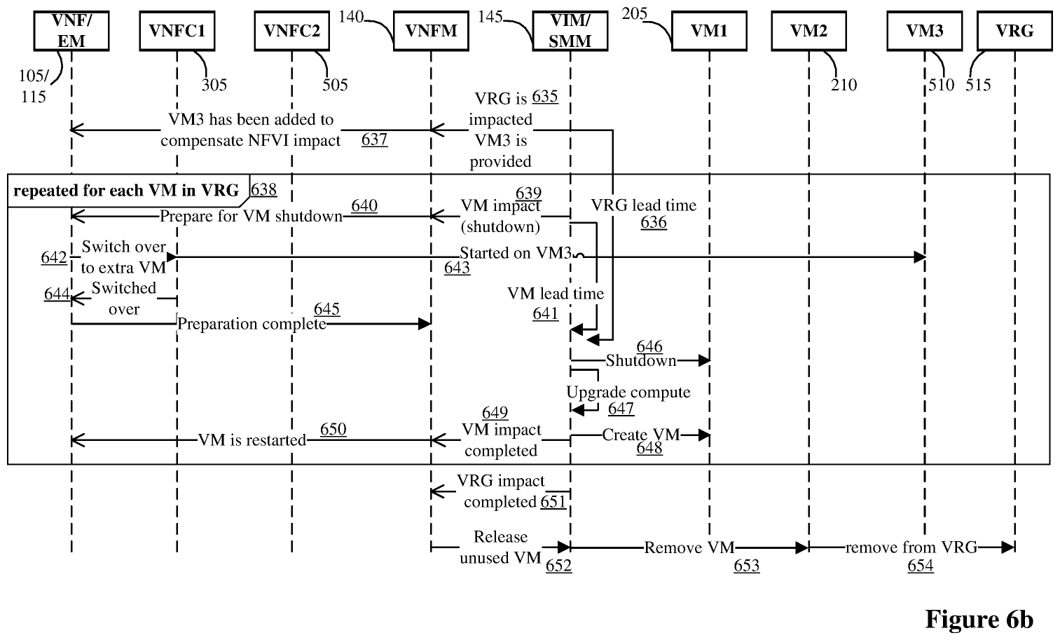

FIGS. 5 and 6 present example scenarios where VRG impact is handled together with the VR impact. Again, the assumption is that the VIM 145 acts as the NFVI-SMM. At step 520, 620, the VNFM 140 allocates the VMs 205, 210, necessary for the VNF 105 in a VRG 515 and requests the impact notifications for the VRG as well as for each VR. It also indicates that, in the VRG, only one VR can be impacted at a time. The VIM/SMM 145 creates the VMs 205, 210 in steps 521, 523, 621, 623 and adds them to VRG 515 in steps 522, 524, 622, 624. The VIM/SMM 145 provides the VMs 205, 210 to the VNFM 140 in step 525, 625. At steps 526-530 and 626-630, on the allocated VM1 and VM2, VNFC1 305 and VNFC2 505 instances are instantiated and started.

In FIG. 5 (split in FIGS. 5a and 5b, which are part of the same flow), the VNFM 140 driven case is presented. At the initiation of the NFVI upgrade, step 531, the VIM/SMM 145 identifies that the VRG is impacted, step 532, and provides the notification to the VNFM 140, step 533. It also starts the lead time timer for the VRG, step 534. The VNFM 140 requests the extra VM for the VRG, step 535, which is provided as VM3 510, steps 536, 538, by the VIM/SMM 145, which also adds VM3 to the VRG, step 537. The VNFM 140 provides VM3 to the VNF 105, step 539, indicating that NFVI impact is expected.

The VIM/SMM 145 provides the impact notification for the to-be-first-impacted VM1 205 with the requested lead time timer, steps 540, 542. As soon as the VNFM 140 receives this notification it notifies the VNF 105, step 541, which now knows that its VNFC1 305, hosted on VM1 205, should be switched over to VM3 510.

The switch over, steps 543-545, needs to complete before the expiration of the VM1 lead time timer as the VIM/SMM 145 shuts down VM1 205, step 547, after the time out. The notification of step 546, regarding completion of the switch over is optional, but could be used by the VNFM to notify the VIM/SMM that the upgrade can begin. This is followed by the upgrade of the compute host hosting VM1, step 548, and VM1 205 is recreated once the upgrade is completed, step 549. The VIM/SMM 145 returns the re-created VM1 205 to the VNF 105 via the VNFM 140, steps 550, 551.

Next, VM2 is going to be impacted and the VIM/SMM 145 signals this to the VNFM 140, step 552, and in turn to the VNF 105, step 554. The VIM/SMM also starts the lead time timer, step 553. Since the VNF 105 has VM1 205 as extra resource, it switches the impacted VNFC2 505 to VM1 205, steps 555-557 and by that is ready for the impact. The notification of step 558 is optional, as explained previously. The VIM/SMM 145 shuts down VM2 210, step 559, at the expiration of its lead time timer and upgrades its host, step 560. After this, it returns the recreated VM2 210, step 561, to the VNFM 140, step 562, which in turn provides it to the VNF, step 563.

At this point, if VM3 510 was created on an already upgraded host, then there is no more impact expected to VRG, so the VIM/SMM 145 signals the completion of the VRG impact to the VNFM 140, step 564. In turn the VNFM 140 releases the extra VM2 210 back to the VIM 145, step 565. The VIM shuts down VM2, step 566, and VM2 is removed from the VRG, step 567.

It should be noted that, in this scenario, the VRG and VR lead times are requested in such a way that the VNFM 140 is able to obtain the extra resource and the VNF 105 is able to switch over the impacted VNFC instance 305, 505 to the extra resource.

In FIG. 6 (split in FIGS. 6a and 6b, which are part of the same flow), similarly to the case illustrated in FIG. 5, the VRG impact notification is used together with the VR impact notification, but in the case illustrated in FIG. 6, the VIM/SMM 145 is requested to act proactively and to provide the extra resources together with the impact notification. At step 631, the NFVI upgrade is started. Since only one VM 205, 210 can be impacted at a time in the VRG, step 632, the VIM/SMM 145 creates VM3 510 beforehand, step 633, and adds VM3 to the VRG, step 634. The VIM/SMM provides the VNFM with the VRG impact notification, step 635. It also starts the lead time timer for the VRG, step 636. The VNFM 140 provides VM3 to the VNF 105, step 637, indicating that NFVI impact is expected. The following steps 639-650 can be executed iteratively, 638. The VIM/SMM also provides the VM impact notification one by one for each impacted VM 205, 210, step 639, with the requested lead time, step 641. The VNFM signals to the VNF to prepare for VM shutdown, step 640. The VNF switches over the VNFC to the extra VM, steps 642-644 and indicates to the VNFM 140 that preparation is complete, step 645. Once the lead time expires, the VIM shuts down the impacted VM, step 646, upgrades the host, step 647, and re-creates the VM, step 648, which it returns to the VNF 105, steps 649, 650. A VRG impact completed notification is sent from the VIM to the VNFM, step 651.

On the VNF 105 side the actions are similar as in the case illustrated in FIG. 5. When the VNF receives the VM impact notification, step 640, it knows which VNFC instance 305, 505 needs to be switched over to the extra VM. After the impact, the re-created VM, on the other hand, is used by the VNF 105 as an extra resource for the next impact until the VRG impact completion notification is received. At this point the VNFM 140 releases the extra VM to the VIM 145, step 652. The VIM removes the extra VM, step 653, and the VM is removed from the VRG, step 654.

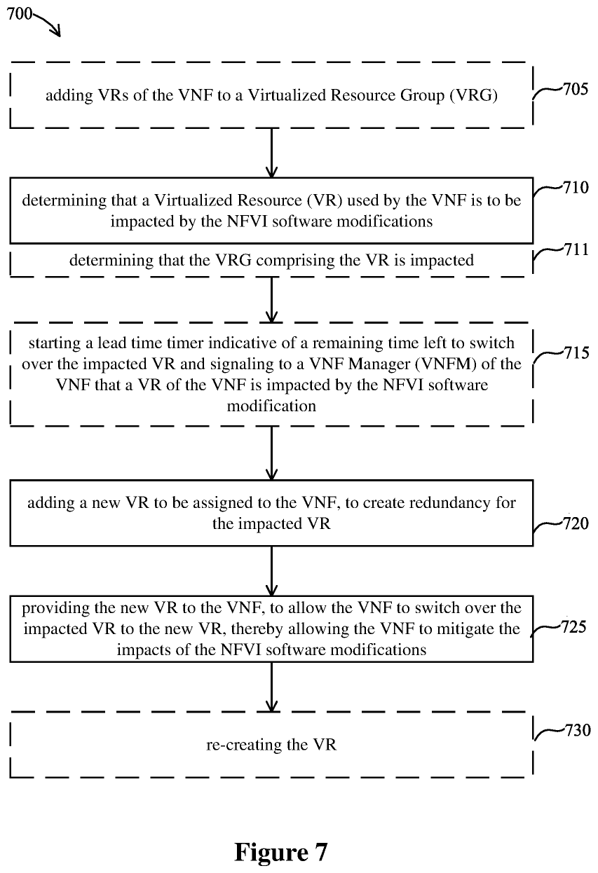

FIG. 7 illustrates a method 700, executed by a Software Modification Manager (SMM), for mitigating impacts of a Network Function Virtualization Infrastructure (NFVI) software modification on a running Virtualized Network Function (VNF) The method comprises determining, step 710, that a Virtualized Resource (VR) used by the VNF is to be impacted by the NFVI software modification; adding or creating, step 720, a new VR to be assigned to the VNF, to create redundancy for the impacted VR; and providing, step 725, the new VR to the VNF, to allow the VNF to switch over the impacted VR to the new VR, thereby allowing the VNF to mitigate the impacts of the NFVI software modification.

The method may further comprise, after determining that a VR is to be impacted, starting, step 715, a lead time timer indicative of a remaining time left to switch over the impacted VR and signaling to a VNF Manager (VNFM) of the VNF that a VR of the VNF is impacted by the NFVI software modification.

The signaling to the VNFM of the VNF that the VR of the VNF is impacted by the NFVI software modification may further comprise signaling that the impacted VR needs to be shut down or migrated.

The method may further comprise, after the shutting down or while migrating of the VR is completed, re-creating the VR, step 730.

The method may further comprise, adding, step 705, VRs of the VNF to a Virtualized Resource Group (VRG), and determining that the VR used by the VNF is to be impacted by the NFVI software modification may comprise determining, step 711, that the VRG comprising the VR is impacted.

The method may be executed iteratively, and the re-created VR may be used as the new VR to which another impacted VR switches over.

The NFVI software modification may comprise any one of NFVI upgrade, NFVI update, NFVI maintenance, NFVI diagnostics, or any other kind of modification.

Referring to FIGS. 1 and 3 to 6, there is provided a network node 145 (however the SMM can be implemented in a node other that VIM 145), executing Software Modification Manager (SMM), for mitigating impacts of a Network Function Virtualization Infrastructure (NFVI) software modification on a running Virtualized Network Function (VNF). The network node runs in a cloud computing environment which provides processing and interface circuitry and memory for running the network node. The memory contains instructions executable by the processing circuitry whereby the network node is operative to execute any of the steps of the method described previously.

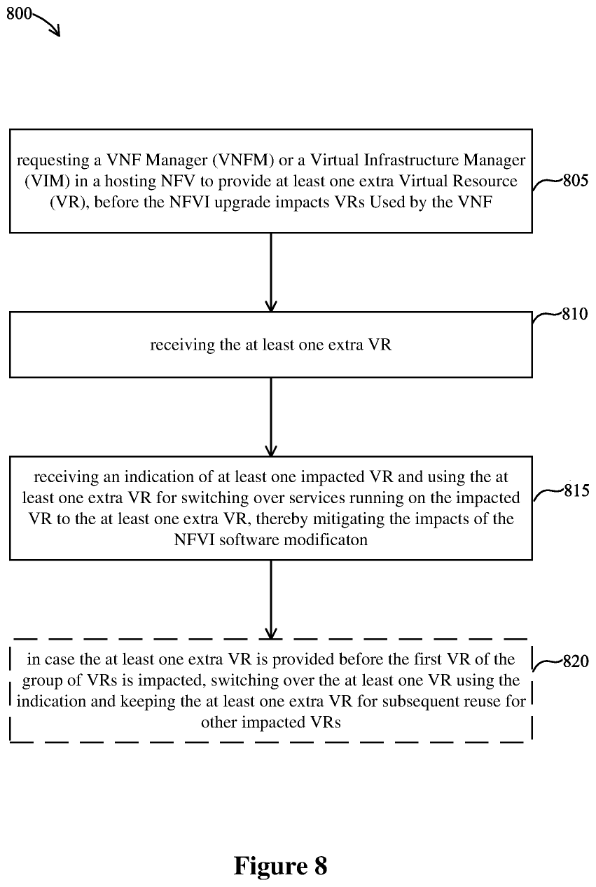

FIG. 8 illustrate a method 800, executed by a Virtualized Network Function (VNF) or an Element Manager of the VNF, for mitigating impacts of Network Function Virtualization Infrastructure (NFVI) software modification or upgrade. The method comprises requesting, step 805, a VNF Manager (VNFM) or a Virtual Infrastructure Manager (VIM) in a hosting NFV to provide at least one extra Virtual Resource (VR), before the NFVI upgrade impacts VRs used by the VNF; receiving, step 810, at least one extra VR; and receiving, step 815, an indication of at least one impacted VR and using the at least one extra VR for switching over services running on the impacted VR to the at least one extra VR, thereby mitigating the impacts of the NFVI software modification.

At least one extra VR may be provided before a time when a first VR is impacted.

The at least one extra VR may be provided before a time when a first VR of a group of VRs is impacted. The method may further comprise, in case the at least one extra VR is provided before the first VR of the group of VRs is impacted, switching over the at least one impacted VR using the indication and keeping the at least one extra VR for subsequent reuse for other impacted VRs, step 820. A number of needed extra VRs may be determined by constraints of simultaneous impact.

Referring to FIGS. 1, 3, 4 and 6, there is provided a network node 115 (however the Virtualized Network Function (VNF) or Element Manager of the VNF can be implemented in a node other that EM 115) executing a Virtualized Network Function (VNF) or an Element Manager of the VNF, for mitigating impacts of Network Function Virtualization Infrastructure (NFVI) upgrade/update/modification. The network node runs in a cloud computing environment which provides processing and interface circuitry and memory for running the network node. The memory contains instructions executable by the processing circuitry whereby the network node is operative to execute any of the steps of the method described previously.

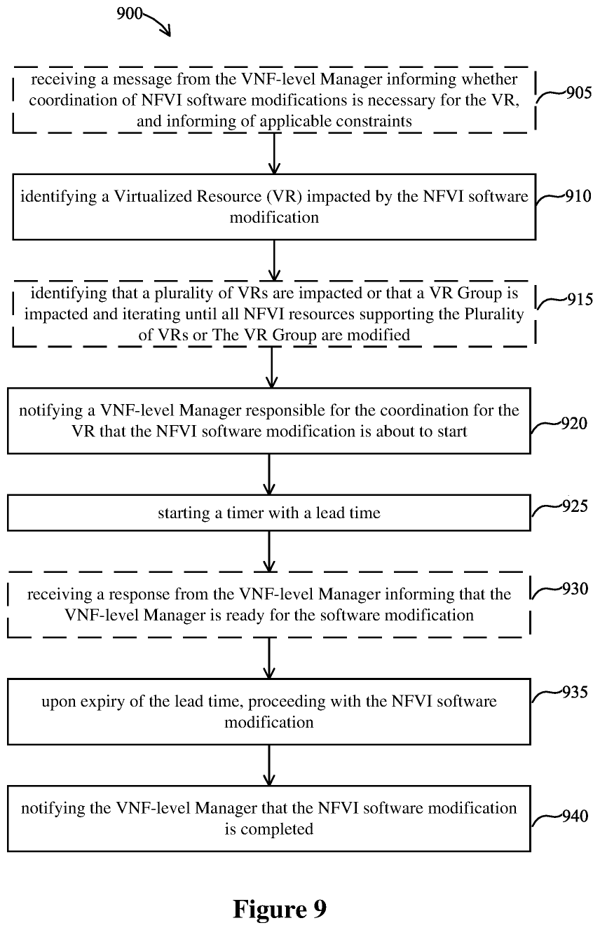

FIG. 9 illustrates a method 900, executed by a NFVI Software Modification Manager, for coordination of Network Function Virtualization Infrastructure (NFVI) software modification. The method comprises identifying, step 910, a Virtualized Resource (VR) impacted by the NFVI software modification; notifying, step 920 a VNF-level Manager responsible for the coordination for the VR that the NFVI software modification is about to start; starting, step 925, a timer with a lead time; upon expiry of the lead time, proceeding, step 935, with the NFVI software modification; and notifying, step 940, the VNF-level Manager that the NFVI software modification is completed.

The method may further comprise receiving, step 905, a message from the VNF-level Manager informing whether coordination of NFVI software modifications is necessary for the VR, and informing of applicable constraints. The method may further comprise receiving, step 930, a response from the VNF-level Manager informing that the VNF-level Manager is ready for the software modification and proceeding with the software modification of the NFVI resources may start before the lead time expires if all responses have been received. The lead time may be determined as a maximum lead time imposed by the constraints. The constraints may comprise any one or a plurality of: a need to notifying the VNF-level Manager that the NFVI software modification is about to start before the virtualized resources is impacted; an upper time limit at which virtual resource migration is feasible otherwise shutdown is preferred; a minimum number of virtual resources that need to be available; or a maximum number of virtual resources that can be impacted simultaneously.

The method may further comprise identifying, step 915, that a plurality of VRs are impacted or that a VR Group is impacted and iterating until all NFVI resources supporting the plurality of VRs or the VR Group are modified.

Referring to FIGS. 1 and 3 to 6, there is provided a network node 145 (however the SMM can be implemented in a node other that VIM 145), executing a NFVI Software Modification Manager for coordination of Network Function Virtualization Infrastructure (NFVI) software modification. The network node runs in a cloud computing environment which provides processing and interface circuitry and memory for running the network node. The memory contains instructions executable by the processing circuitry whereby the network node is operative to execute any of the steps of the method described previously.

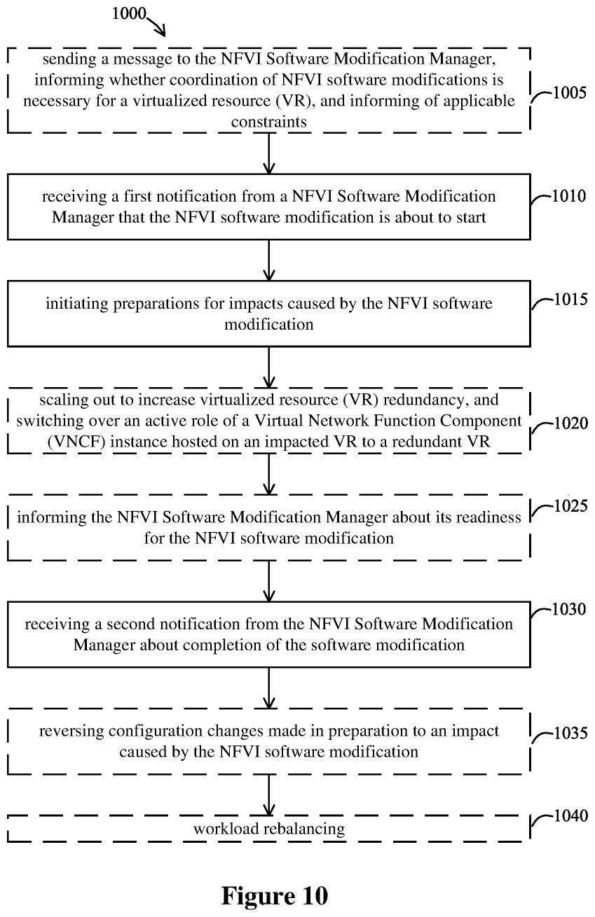

FIG. 10 illustrates a method 1000, executed by a Virtualized Network Function (VNF)-level Manager, for coordination of Network Function Virtualization Infrastructure (NFVI) software modification. The method comprises receiving, step 1010, a first notification from a NFVI Software Modification Manager that the NFVI software modification is about to start; initiating, step 1015, preparations for impacts caused by the NFVI software modification; and receiving, step 1030, a second notification from the NFVI Software Modification Manager about completion of the software modification.

The method may further comprise sending, step 1005, a message to the NFVI Software Modification Manager, informing whether coordination of NFVI software modifications is necessary for a virtualized resource (VR), and informing of applicable constraints. The method may further comprise scaling out, step 1020, to increase virtualized resource (VR) redundancy, and switching over an active role of a Virtual Network Function Component (VNCF) instance hosted on an impacted VR to a redundant VR. The method may further comprise informing, step 1025, the NFVI Software Modification Manager about its readiness for the NFVI software modification. The method may further comprise reversing, step 1035, configuration changes made in preparation to an impact caused by the NFVI software modification or workload rebalancing, step 1040.

Referring to FIGS. 1, 3, 4 and 6, there is provided a network node 115 (however the Virtualized Network Function (VNF) or Element Manager of the VNF can be implemented in a node other that EM 115), executing a Virtualized Network Function (VNF)-level Manager for coordination of Network Function Virtualization Infrastructure (NFVI) software modification. The network node runs in a cloud computing environment which provides processing and interface circuitry and memory for running the network node. The memory contains instructions executable by the processing circuitry whereby the network node is operative to execute any of the steps of the method described previously.

There is also provided a non-transitory computer readable media having stored thereon instructions for executing any of the steps of the methods provided herein.

Returning to FIG. 1, there is provided a system 100, virtual server or virtual apparatus, for mitigating impacts of Network Function Virtualization Infrastructure (NFVI) software modifications, the system 100, virtual server or virtual apparatus running in a cloud computing environment which provides processing and interface circuitry and memory for running the system 100, virtual server or virtual apparatus, the memory containing instructions executable by the processing circuitry whereby the system 100, virtual server or virtual apparatus is operative to execute any of the steps of the methods provided herein.

In some embodiments, some or all the functions described herein may be implemented as virtual components executed by one or more virtual machines implemented in one or more virtual environments 100 hosted by one or more hardware nodes 150. The functions may be implemented by one or more applications (which may alternatively be called software instances, virtual appliances, network functions, virtual nodes, virtual network functions, etc.) operative to implement steps of some methods according to some embodiments. The applications run in virtualization environment 100 which provides hardware 150 comprising processing circuitry, networking hardware and memory/storage. The memory contains instructions executable by processing circuitry whereby the applications are operative to provide any of the relevant features, benefits, and/or functions disclosed herein.

Virtualization environment 100, may comprise general-purpose or special-purpose network hardware devices comprising a set of one or more processors or processing circuitry, which may be commercial off-the-shelf (COTS) processors, dedicated Application Specific Integrated Circuits (ASICs), or any other type of processing circuitry including digital or analog hardware components or special purpose processors. Each hardware device may comprise memory which may be non-persistent memory for temporarily storing instructions or software executed by the processing circuitry. Each hardware devices may comprise one or more network interface controllers (NICs), also known as network interface cards, which include physical network interface. Each hardware devices may also include non-transitory, persistent, machine-readable storage media having stored therein software and/or instruction executable by processing circuitry. Software may include any type of software including software for instantiating one or more virtualization layers (also referred to as hypervisors), software to execute virtual machines as well as software allowing to execute functions described in relation with some embodiments described herein.

Virtualization of the hardware may be referred to as network function virtualization (NFV). NFV may be used to consolidate many network equipment types onto industry standard high-volume server hardware, physical switches, and physical storage, which can be located in data centers, and customer premise equipment.

Modifications and other embodiments will come to mind to one skilled in the art having the benefit of the teachings presented in the foregoing description and the associated drawings. Therefore, it is to be understood that modifications and other embodiments, such as specific forms other than those of the embodiments described above, are intended to be included within the scope of this disclosure. The described embodiments are merely illustrative and should not be considered restrictive in any way.

1. A method, executed by a NFVI Software Modification Manager, for coordination of Network Function Virtualization Infrastructure (NFVI) software modification, comprising:
identifying a Virtualized Resource (VR) impacted by the NFVI software modification;
notifying a VNF-level Manager responsible for the coordination for the VR that the NFVI software modification is about to start;
starting a timer with a lead time;
upon expiry of the lead time, proceeding with the NFVI software modification; and
notifying the VNF-level Manager that the NFVI software modification is completed.

2. The method of claim 1, further comprising receiving a message from the VNF-level Manager informing whether coordination of NFVI software modifications is necessary for the VR, and informing of applicable constraints.

3. The method of claim 1, further comprising receiving a response from the VNF-level Manager informing that the VNF-level Manager is ready for the software modification and wherein proceeding with the software modification of the NFVI resources starts before the lead time expires if all responses have been received.

4. The method of claim 2, wherein the lead time is determined as a maximum lead time imposed by the constraints.

5. The method of claim 4, wherein the constraints comprise any one or a plurality of:
a need to notifying the VNF-level Manager that the NFVI software modification is about to start before the virtualized resources is impacted;
an upper time limit at which virtual resource migration is feasible otherwise shutdown is preferred;
a minimum number of virtual resources that need to be available; or
a maximum number of virtual resources that can be impacted simultaneously.

6. The method of claim 5, further comprising identifying that a plurality of VRs are impacted or that a VR Group is impacted and iterating until all NFVI resources supporting the plurality of VRs or the VR Group are modified.

7. A network node, executing a NFVI Software Modification Manager for coordination of Network Function Virtualization Infrastructure (NFVI) software modification, the network node running in a cloud computing environment which provides processing and interface circuitry and memory for running the network node, the memory containing instructions executable by the processing circuitry whereby the network node is operative to:
identify a Virtualized Resource (VR) impacted by the NFVI software modification;
notify a VNF-level Manager responsible for the coordination for the VR that the NFVI software modification is about to start;
start a timer with a lead time;
upon expiry of the lead time, proceed with the NFVI software modification; and
notify the VNF-level Manager that the NFVI software modification is completed.

8. A method, executed by a Virtualized Network Function (VNF)-level Manager, for coordination of Network Function Virtualization Infrastructure (NFVI) software modification, comprising:
receiving a first notification from a NFVI Software Modification Manager that the NFVI software modification is about to start;
initiating preparations for impacts caused by the NFVI software modification; and
receiving a second notification from the NFVI Software Modification Manager about completion of the software modification.

9. The method of claim 8, further comprising sending a message to the NFVI Software Modification Manager, informing whether coordination of NFVI software modifications is necessary for a virtualized resource (VR), and informing of applicable constraints.

10. The method of claim 8, further comprising scaling out to increase virtualized resource (VR) redundancy, and switching over an active role of a Virtual Network Function Component (VNCF) instance hosted on an impacted VR to a redundant VR.

11. The method of claim 8, further comprising informing the NFVI Software Modification Manager about its readiness for the NFVI software modification.

12. The method of claim 8, further comprising reversing configuration changes made in preparation to an impact caused by the NFVI software modification.

13. The method of claim 12, further comprising workload rebalancing.

14. A network node, executing a Virtualized Network Function (VNF)-level Manager for coordination of Network Function Virtualization Infrastructure (NFVI) software modification, the network node running in a cloud computing environment which provides processing and interface circuitry and memory for running the network node, the memory containing instructions executable by the processing circuitry whereby the network node is operative to:
receive a first notification from a NFVI Software Modification Manager that the NFVI software modification is about to start;
initiate preparations for impacts caused by the NFVI software modification; and
receive a second notification from the NFVI Software Modification Manager about completion of the software modification.

15-28. (canceled)

29. A non-transitory computer readable media having stored thereon instructions for executing the steps of:
identifying a Virtualized Resource (VR) impacted by the NFVI software modification;
notifying a VNF-level Manager responsible for the coordination for the VR that the NFVI software modification is about to start;
starting a timer with a lead time;
upon expiry of the lead time, proceeding with the NFVI software modification; and
notifying the VNF-level Manager that the NFVI software modification is completed.

30. A non-transitory computer readable media having stored thereon instructions for executing the steps of:
receiving a first notification from a NFVI Software Modification Manager that the NFVI software modification is about to start;
initiating preparations for impacts caused by the NFVI software modification; and
receiving a second notification from the NFVI Software Modification Manager about completion of the software modification.
